(19) United States
(12) Patent Application Publication
(10) Pub. No.: US 2024/0370890 A1
(43) Pub. Date: Nov. 7, 2024

(54) DEMAND PREDICTION DEVICE, DEMAND PREDICTION METHOD, AND STORAGE MEDIUM

(71) Applicant: HONDA MOTOR CO., LTD., Minato-ku, Tokyo (JP)

(72) Inventors: Satoshi Yoshimaru, Tokyo (JP); Kohei Mukaihara, Tokyo (JP)

(21) Appl. No.: 18/686,883

(22) PCT Filed: Aug. 26, 2022
(86) PCT No.: PCT/JP2022/032167

§ 371 Date: Feb. 27, 2024

(30) Foreign Application Priority Data
Sep. 28, 2021 (JP) 2021-158342

(51) Int. Cl. G06Q 30/0202; G06Q 10/20

(52) U.S. Cl. CPC G06Q 30/0202; G06Q 10/20

(57) ABSTRACT

A demand prediction device predicts demand for a component of a vehicle in preparation for replacement or repair of the component and includes: an acquirer configured to acquire a result value of the demand for the component, an operation value associated with operation of vehicles using the component, and an existing predicted value which is a predicted demand for the component; and a predictor configured to predict the demand on the basis of the result value, the operation value, and the existing predicted value.

### TECHNICAL FIELD

The present invention relates to a demand prediction device, a demand prediction method, and a storage medium.

Priority is claimed on Japanese Patent Application No. 2021-158342, filed Sep. 28, 2021, the content of which is incorporated herein by reference.

### BACKGROUND ART

In the related art, a component demand prediction storage medium for predicting demand for a component using a replacement factor and operation characteristics of the component is disclosed (for example, see Patent Document 1).

### CITATION LIST

### Patent Document

### Patent Document 1

Japanese Unexamined Patent Application, First Publication No. 2007-199844

### SUMMARY OF INVENTION

### Technical Problem

However, the prediction technique may not be satisfactorily accurate.

The present invention was made in consideration of the aforementioned circumstances and the objective thereof is to more accurately predict demand for a component.

### Solution to Problem

A demand prediction device, a demand prediction system, a demand prediction method, and a storage medium according to the present invention employ the following configurations.

(1) According to an aspect of the present invention, there is provided a demand prediction device that predicts demand for a component of a vehicle in preparation for replacement or repair of the component, the demand prediction device including: an acquirer configured to acquire a result value of the demand for the component, an operation value associated with operation of vehicles using the component, and an existing predicted value which is the predicted demand for the component; and a predictor configured to predict the demand on the basis of the result value, the operation value, and the existing predicted value.

(2) In the aspect of (1), the predictor predicts the demand on the basis of a relative relationship among an index acquired from the operation value, the existing predicted value, and an index acquired from the result value.

(3) In the aspect of (1) or (2), the predictor determines whether the existing predicted value is to be employed as a predicted value or whether a value obtained by correcting the existing predicted value is to be employed as a predicted value on the basis of a relative relationship among an index acquired from a tendency of increase or decrease of the operation value, the existing predicted value, and an index acquired from the result value.

(4) In the aspect of (3), the tendency of increase or decrease of the operation value in a time series is equal to or similar to a tendency of increase or decrease of the result value, and the predictor predicts the demand on the basis of the tendency of increase or decrease of the operation value and the tendency of increase or decrease of the result value in the time series.

(5) In the aspect of (3) or (4), a tendency of fluctuation of the operation value in a time series is equal to or similar to a tendency of fluctuation of the result value, and the predictor predicts the demand on the basis of the tendency of fluctuation of the operation value and the tendency of fluctuation of the result value in the time series.

(6) In any one of the aspects of (1) to (5), the acquirer acquires the result value for every predetermined period, the operation value for every predetermined period, and the existing predicted value for every predetermined period, and the predictor determines a value obtained by decreasing the existing predicted value at a third time point later than a first time point as a predicted value on the basis of a difference between the operation value at the first time point and the operation value at a second time point earlier than the first time point when the operation value at the first time point tends to increase with respect to the operation value at the second time point.

(7) In any one of the aspects of (1) to (6), the acquirer acquires the result value for every predetermined period, the operation value for every predetermined period, and the existing predicted value for every predetermined period, and the predictor determines a value obtained by increasing the existing predicted value at a third time point later than a first time point as a predicted value on the basis of a difference between the operation value at the first time point and the operation value at a second time point earlier than the first time point when the operation value at the first time point tends to decrease with respect to the operation value at the second time point.

(8) In any one of the aspects of (1) to (7), the acquirer acquires the result value for every predetermined period, the operation value for every predetermined period, and the existing predicted value for every predetermined period, the predictor acquires an index based on the result value at a third time point later than a first time point on the basis of the result value at the first time point and the result value at a second time point earlier than the first time point, and the predictor compares the existing predicted value at the third time point and a magnitude of an index based on the result value and determines whether the existing predicted value at the third time point is to be used as a predicted value at the third time or whether a value obtained by correcting the existing predicted value at the third time point on the basis of the operation value at the first time point and the operation value at the second time point is to be used as the predicted value at the third time point on the basis of the result of comparison.

(9) In the aspect of (8), the predictor determines the existing predicted value at the third time point to be the predicted value at the third time point when the existing predicted value at the third time point is equal to or greater than the index based on the result value, and the predictor determines a value obtained by correcting the existing predicted value at the third time point on the basis of the operation value at the first time point and the operation value at the second time point to be the predicted value at the third time point when the existing predicted value at the third time point is less than the index based on the result value.

(10) In any one of the aspects of (1) to (9), the operation value of vehicles is information indicating an actual travel state of the vehicles correlated with a predetermined area.

(11) According to another aspect of the present invention, there is provided a demand prediction system for predicting demand for a component of a vehicle in preparation for replacement or repair of the component, the demand prediction system performing: acquiring a result value of the demand for the component; acquiring an operation value associated with operation of vehicles using the component; acquiring an existing predicted value which is a predicted demand for the component; and predicting the demand on the basis of the result value, the operation value, and the existing predicted value. The aspect of (11) may be as follows. That is, there is provided a demand prediction method of predicting the demand for a component of a vehicle in preparation for replacement or repair of the component, the demand prediction method including: acquiring a result value of the demand for the component; acquiring an operation value associated with operation of vehicles using the component; acquiring an existing predicted value which is a predicted demand for the component; and predicting the demand on the basis of the result value, the operation value, and the existing predicted value.

(12) According to another aspect of the present invention, there is provided a non-transitory storage medium storing a program, the program causing a computer to predict demand for a component of a vehicle in preparation for replacement or repair of the component, the program causing the computer to perform: acquiring a result value of the demand for the component; acquiring an operation value associated with operation of vehicles using the component; acquiring an existing predicted value which is a predicted demand for the component; and predicting the demand on the basis of the result value, the operation value, and the existing predicted value.

### Advantageous Effects of Invention

With the demand prediction device, the demand prediction system, the storage medium according to the aspects of (1) to (12), it is possible to more accurately predict demand for a component by predicting the demand on the basis of the result value, the operation value, and the existing predicted value.

With the demand prediction device according to the aspect of (8) or (9), it is possible to curb an increase of a predicted value by determining a predicted value at a third time point on the basis of a relationship between the existing predicted value and an index based on the result value.

### BRIEF DESCRIPTION OF DRAWINGS

FIG. 1 is a diagram illustrating an example of a configuration of a prediction system 1 including an information provision device and the demand prediction device.

FIG. 2 is a diagram illustrating an example of a functional configuration of a vehicle system 10 that is mounted in a vehicle M.

FIG. 3 is a diagram illustrating an example of functional configurations of an information processing device 100 and a prediction device 200.

FIG. 4 is a flowchart illustrating an example of a process flow that is performed by the information processing device 100.

FIG. 5 is a diagram illustrating an example of operation information 144 that is acquired by a second acquirer 120.

FIG. 6 is a diagram illustrating an example of collection information 146.

FIG. 7 is a diagram illustrating actual travel state information 148.

FIG. 8 is a diagram illustrating comparison between actual travel state information 148 and result information 142.

FIG. 9 is a (first) diagram illustrating a process of generating second prediction information 258.

FIG. 10 is a (second) diagram illustrating a process of generating second prediction information 258.

FIG. 11 is a flowchart illustrating an example of a process flow that is performed by the prediction device 200.

FIG. 12 is a diagram illustrating an existing predicted value and a new predicted value.

### DESCRIPTION OF EMBODIMENTS

Hereinafter, a demand prediction device, a demand prediction system, and a storage medium according to an embodiment of the present invention will be described with reference to the accompanying drawings.

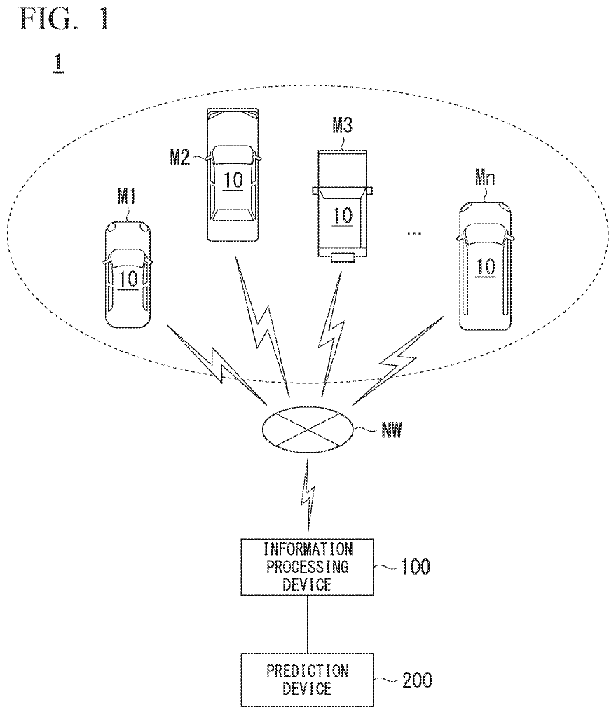

FIG. 1 is a diagram illustrating an example of a configuration of a prediction system 1 including an information provision device and a demand prediction device. The prediction system 1 includes, for example, one or more vehicles M (M1 to Mn in the drawing), an information processing device 100, and a prediction device 200. Each vehicle M and the information processing device 100 can communicate with each other via a network NW. The network NW includes the Internet, a wide area network (WAN), a local area network (LAN), a public line, a provider device, a private line, and a wireless base station. The information processing device 100 and the prediction device 200 can communicate with each other via a private line or the network NW. The information processing device 100 is an example of an “information provision device” in the claims, and the prediction device 200 is an example of a “demand prediction device” in the claims.

### Vehicle

One or more vehicles M are vehicles that are used in a predetermined area. The predetermined area is an area in which the vehicles M are mainly used or an area corresponding to parking spaces of the vehicles M.

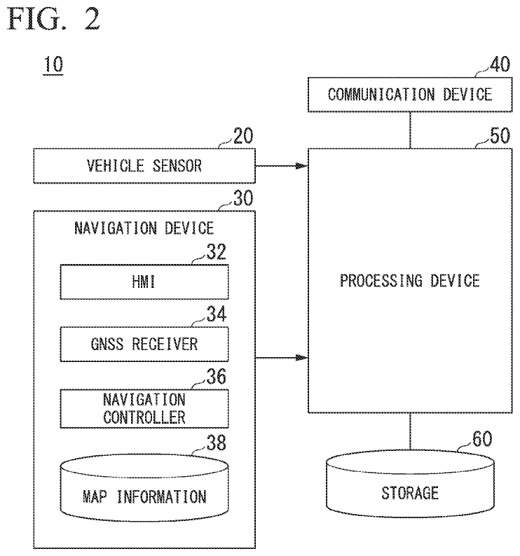

FIG. 2 is a diagram illustrating an example of a functional configuration of the vehicle system 10 mounted in a vehicle M. The vehicle system 10 includes, for example, a vehicle sensor 20, a navigation device 30, a communication device 40, a processing device 50, and a storage 60. The vehicle system 10 includes actuators, electronic devices, and operators for controlling the vehicle which are not illustrated in addition to the aforementioned functional constituents.

The vehicle sensor 20 includes a vehicle speed sensor that detects a speed of the vehicle M, an acceleration sensor that detects acceleration, and a yaw rate sensor that detects a yaw rate (for example, a rotational angular velocity around a vertical axis passing through the center of gravity of the vehicle M), and a direction sensor that detects a direction of the vehicle M. The vehicle sensor 20 may include, for example, a brake pedal sensor that detects an operation performed on a brake pedal or a steering sensor that detects an amount of steering (for example, a steering angle) of the vehicle M. Results detected by the vehicle sensor 20 are output to the processing device 50.

The navigation device 30 includes, for example, a human-machine interface (HMI) 32, a GNSS receiver 34, a navigation controller 36, and map information 38. The HMI 32 includes, for example, a touch-panel display device, a speaker, and a microphone. The GNSS receiver 34 measures a self-position (a position of the vehicle M) on the basis of radio waves transmitted from GNSS satellites (for example, GPS satellites). The navigation controller 36 includes, for example, a central processing unit (CPU) and various storage devices and controls the navigation device 30 as a whole. Map information (navigation maps) 38 is stored in the storage device. The navigation map is a map in which roads are expressed by nodes and links. The navigation device 30 provides position information indicating the measured position to the processing device 50.

The communication device 40 is, for example, a communication interface for communication with another device via the network NW. The communication device 40 performs wireless communication on the basis of communication protocols such as Wi-Fi, Dedicated Short Range Communications (DSRC), and Bluetooth (registered trademark).

The processing device 50 is realized by causing a hardware processor such as a CPU to execute a program (software) stored in the storage device. The storage 60 may be realized, for example, by the aforementioned storage devices, a solid state drive (SSD), a random access memory (RAM), or a hard disc drive (HDD). For example, information output from the vehicle sensor 20 or information supplied from the navigation device 30 is stored in the storage 60.

The processing device 50 provides operation information associated with operation of the vehicle M (information indicating a vehicle state including the state of an ignition switch or a travel state of the vehicle M) such as information output from the vehicle sensor 20, and information supplied from the navigation device 30 to the information processing device 100.

### Information Processing Device

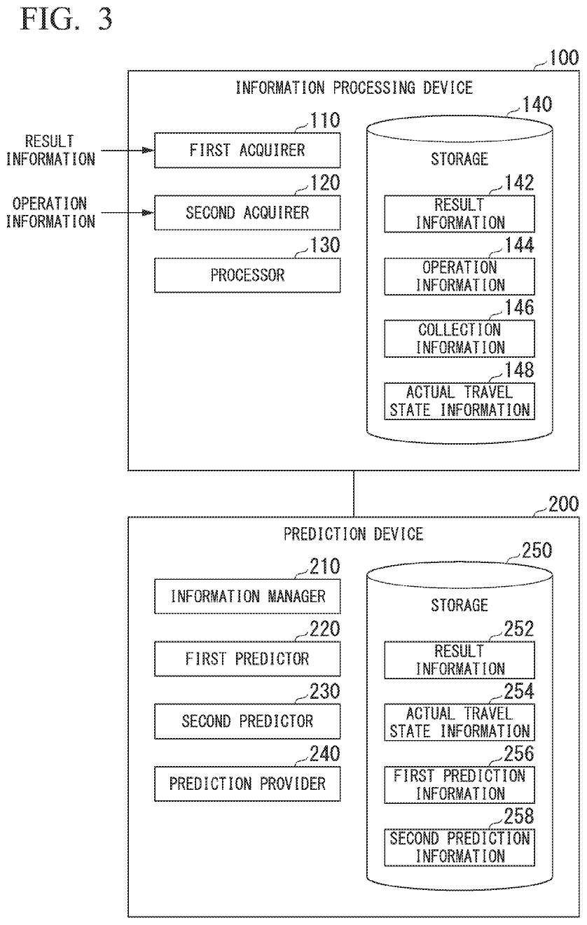

FIG. 3 is a diagram illustrating an example of functional configurations of the information processing device 100 and the prediction device 200.

Some or all of the functional constituents of the information processing device 100 may be included in the prediction device 200. The functional constituents of the information processing device 100 or functions of the prediction device 200 may be distributed to a plurality of devices. The information processing device 100 or the prediction device 200 is a device that is managed by a company such as a vehicle manufacturer manufacturing or selling vehicles M.

The information processing device 100 includes, for example, a first acquirer 110, a second acquirer 120, a processor 130 (an example of a “provider”), and a storage 140. The first acquirer 110, the second acquirer 120, and the processor 130 are realized by causing a hardware processor such as a CPU to execute a program (software). Some or all of these functional constituents may be realized by hardware (a circuit part including circuitry) such as a large scale integration (LSI) circuit, an application-specific integrated circuit (ASIC), a field-programmable gate array (FPGA), or a graphics processing unit (GPU) or may be cooperatively realized by software and hardware. The program may be stored in a storage device (a storage device including a non-transitory storage medium) such as an HDD or a flash memory of the information processing device 100 in advance or may be stored in a detachable storage medium such as a DVD or a CD-ROM and installed in the HDD or the flash memory of the information processing device 100 by setting the storage medium (a non-transitory storage medium) into a drive device.

The storage 140 is realized, for example, by the aforementioned storage devices or an SSD, a RAM, or an HDD. Information (result information 142 and operation information 144) acquired by the first acquirer 110 or the second acquirer 120 which will be described later is stored in the storage 140. Collection information 146 and actual travel state information 148 which are information obtained by causing the processor 130 to process the result information 142 or the operation information 144 are stored in the storage 140. Details of information stored in the storage 140 will be described later.

The first acquirer 110 acquires result information. The result information is information indicating forwarding results of components (information indicating a result value). The result information is information which is provided by a management device (not illustrated) managing stock, forwarding, production, and the like of components. The second acquirer 120 acquires operation information. The operation information is information provided to the processing device 50.

The processor 130 stores the result information 142 acquired by the first acquirer 110 and the operation information 144 acquired by the second acquirer 120 in the storage 140. The processor 130 processes the result information 142 or the operation information 144 and generates information which is used by the prediction device 200. For example, the processor 130 generates collection information 146 and actual travel state information 148 indicating an actual travel state of the vehicle M by processing the operation information 144. The processor 130 provides the generated information to the prediction device 200 at a predetermined timing. The processor 130 provides the result information 142 or the operation information 144 to the prediction device 200, for example, in response to a request from the prediction device 200 or in a predetermined period. The processor 130 may provide the operation information 144 to the prediction device 200, and the prediction device 200 may process the operation information 144.

### Prediction Device

The prediction device 200 includes, for example, an information manager 210 (an example of an “acquirer”), a first predictor 220, a second predictor 230 (an example of a “predictor”), a prediction provider 240, and a storage 250. The information manager 210, the first predictor 220, the second predictor 230, and the prediction provider 240 are realized, for example, by causing a hardware processor such as a CPU to execute a program (software). Some or all of these functional constituents may be realized by hardware (a circuit part including circuitry) such as an LSI circuit, an ASIC, an FPGA, or a GPU or may be cooperatively realized by software and hardware. The program may be stored in a storage device (a storage device including a non-transitory storage medium) such as an HDD or a flash memory of the prediction device 200 in advance or may be stored in a detachable storage medium such as a DVD or a CD-ROM and installed in the HDD or the flash memory of the information processing device 100 by setting the storage medium (a non-transitory storage medium) into a drive device.

The storage 250 is realized, for example, by the aforementioned various types of storage devices or an SSD, a RAM, or an HDD. Result information 252 and actual travel state information 254 acquired by the information manager 210 which will be described later is stored in the storage 250. First prediction information 256 on demand for components predicted by the first predictor 220 and second prediction information 258 on demand for components predicted by the second predictor 230 are stored in the storage 250.

The information manager 210 manages various types of information. The information manager 210 acquires or manages information provided by the information processing device 100 or information obtained by the prediction device 200 performing processing thereon. The information manager 210 stores the result information 142 and the actual travel state information 148 provided by the information processing device 100 in the storage 250 or stores results of prediction from the first predictor 220 or the second predictor 230 in the storage 250.

The first predictor 220 predicts demands for components. The second predictor 230 predicts demand on the basis of the result information 252 and the actual travel state information 254. The second predictor 230 predicts demand for a component for each vehicle model of vehicles M (or for each group of specific vehicle models), for each component, or for each combination of a vehicle model and a component. Details of this process will be described later.

The prediction provider 240 provides a prediction result from the second predictor 230 to another device. The other device is a terminal device of a company or a department taking charge of managing components or a terminal device of a company or a department taking charge of manufacturing components.

### Process of Information Processing Device

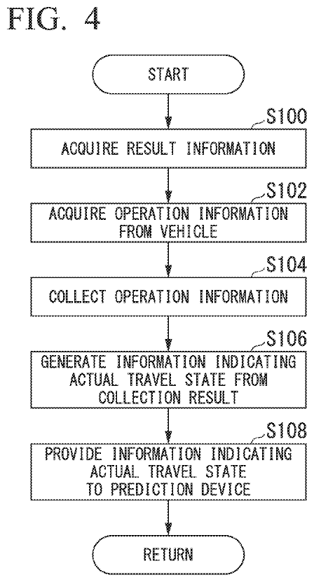

FIG. 4 is a flowchart illustrating an example of a process flow which is performed by the information processing device 100. First, the first acquirer 110 acquires result information 142 (Step S100).

Then, the second acquirer 120 acquires operation information 144 from vehicles M (Step S102). Then, the processor 130 collects the operation information 144 (Step S104). The collected operation information 144 may be referred to as collection information in the following description. Then, the processor 130 generates actual travel state information 148 by processing the collection information 146 (Step S106). Then, the processor 130 provides the generated actual travel state information 148 to the prediction device 200. Accordingly, one routine of the flowchart ends.

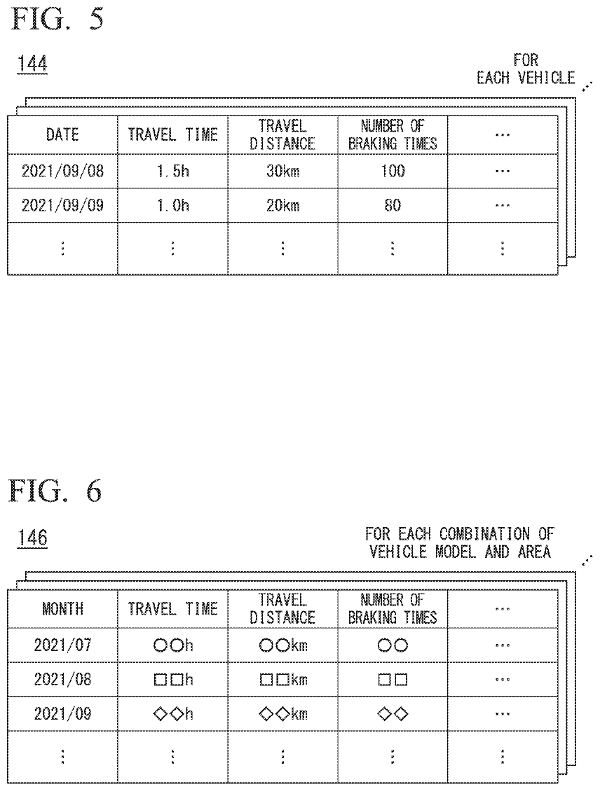

FIG. 5 is a diagram illustrating an example of the operation information 144 acquired by the second acquirer 120. The operation information 144 is information in which a date (or a date and time) and information indicating an operation situation of a vehicle M are correlated for each vehicle M. The information indicating an operation situation is information indicating an operation state or a travel state of a vehicle M such as a travel time, a travel distance, and the number of braking times. The travel time may be a time until an ignition switch of the vehicle M is switched to an off state after the ignition switch has been turned on or a time in which the vehicle M is traveling actually at a predetermined speed or higher. The number of braking times is the number of braking operations or the number of times a braking operation of a predetermined degree or higher has been performed. The operation situation may include the number of times acceleration or deceleration has changed by a predetermined degree or more (the number of times of sudden acceleration or sudden deceleration) or the number of times lateral acceleration of the vehicle M has changed by a predetermined degree or more (the number of sudden turns).

Instead of (or in addition to) direct acquisition of the operation information 144 from the vehicle M, the information processing device 100 may acquire the operation information 144 (or the collection information) from a navigation server (not illustrated) acquiring information of the vehicle M by communicating with the navigation device 30 of the vehicle M or another device acquiring information of the vehicle M. The information processing device 100 may acquire position information (information in which position information and time are correlated) of the vehicle M from the vehicle M and generate the operation information 144 on the basis of the acquired position information. For example, the information processing device 100 may generate a travel distance or a travel time of the vehicle from the position information.

FIG. 6 is a diagram illustrating an example of collection information 146. The collection information 146 is, for example, information indicating a collection result of the operation information 144 every predetermined period and is information indicating a collection result of the operation information 144 for each combination of vehicles of the same vehicle model and vehicles of the same belonging area. The predetermined period is an arbitrarily determined period such as a month or a week. The belonging area is an area to which a vehicle M which is an information source belongs. An area to which a vehicle M belongs is, for example, an area corresponding to a position of a parking lot of the vehicle M (for example, an area of a position at which a parking time is long), an area in which a travel time is long, or an area in which a store managing the vehicle M (a seller or a repair shop of the vehicle M) is present. The collection information 146 is, for example, information including a travel time, a travel distance, and the number of braking times of the vehicle M of a vehicle model belonging to area A for each month. The collection information 146 or the actual travel state information 148 which will be described later is an example of “information indicating an actual travel state of a vehicle correlated with a predetermined area.”

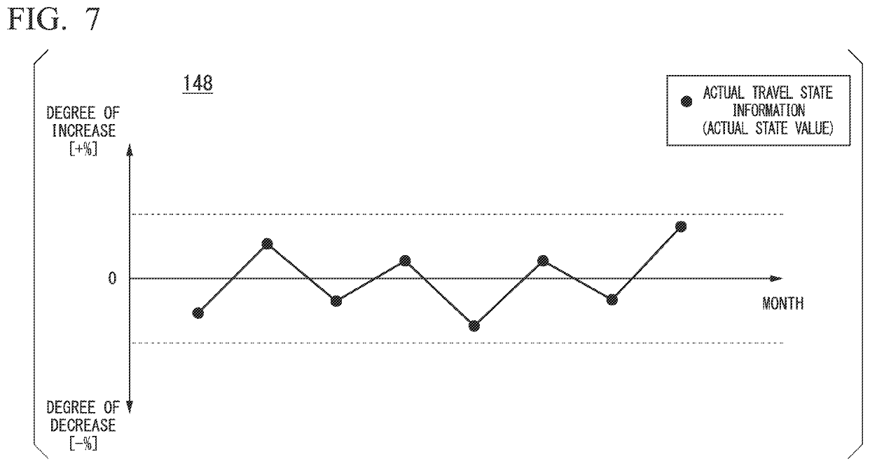

FIG. 7 is a diagram illustrating the actual travel state information 148. The actual travel state information 148 is information indicating actual travel states of vehicles M for each area and each vehicle model acquired from the collection information 146. For example, the actual travel state information 148 is information indicating increase or decrease of predetermined items (such as the travel time, the travel distance, and the number of braking times) in the collection information 146 every predetermined period. The actual travel state information 148 may be information generated with attention to an arbitrary item out of the items (such as the travel time, the travel distance, and the number of braking times) in the collection information 146 or may be information generated with attention to all the items. The actual travel state information 148 may be information acquired by scoring an arbitrary item.

In the example illustrated in FIG. 7, actual travel state information 148 generated with attention to the travel time (an actual state value) in the collection information 146 is described. In the actual travel state information 148 illustrated in FIG. 7, a degree of increase and a degree of decrease of the travel time of a vehicle M every month are described. As illustrated in FIG. 7, the travel time of a vehicle M tends to alternately increase and decrease, and the fluctuation of increase and decrease tends to be in a predetermined range.

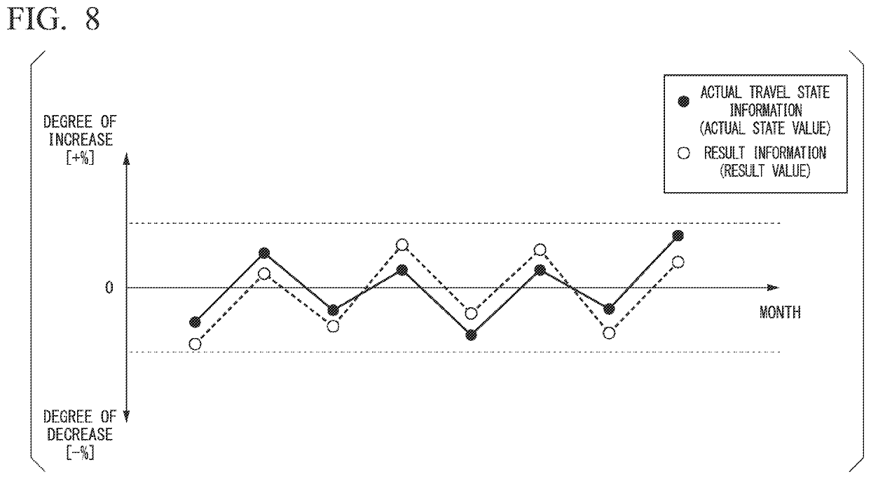

As can be seen through comparison between the actual travel state information 148 and the result information 142, the tendencies of increase and decrease and the fluctuation thereof interlink with each other. FIG. 8 is a diagram illustrating comparison between the actual travel state information 148 and the result information 142. As illustrated in FIG. 8, the tendencies of increase and decrease in the result information 142 (result values) indicating the number of components actually forwarded in a time series and the tendencies of increase and decrease in the actual travel state information 148 are equal to or similar to each other. As illustrated in FIG. 8, the tendency of fluctuation in the result information 142 (result values) indicating the number of components actually forwarded and the tendency of fluctuation in the actual travel state information 148 are equal to or similar to each other. The increase and decrease of the travel time of a vehicle M every month and the increase and decrease of the number of components forwarded every month interlink with each other (feature 1), and the fluctuation of the travel time of the vehicle M every month and the fluctuation of the number of components forwarded every month interlink with each other (feature 2).

The information processing device 100 provides the result information 142 and the actual travel state information 148 to the prediction device 200, and the prediction device 200 more accurately predicts the demand for a component using the tendencies of the actual travel states (feature 1 and feature 2) indicated by the provided result information 142 and the provided actual travel state information 148. In this way, the information processing device 100 can support prediction of the demand for a component in the prediction device 200.

### Process of Prediction Device

The prediction device 200 generates second prediction information 258 on the basis of the result information 252 (142), the actual travel state information 254 (148), and the first prediction information 256.

The result information 252 is the result information 142 provided by the information processing device 100, and the actual travel state information 254 is the actual travel state information 148 provided by the information processing device 100. For example, the first prediction information 256 is information indicating a predicted demand for a component (information indicating an existing predicted value) predicted on the basis of various indices by the first predictor 220. The first prediction information 256 is information generated on the basis of tendencies of the number of components forwarded up to the current time and various economic indicators. The economic indicators include, for example, a gross domestic product (GDP), an industrial production index, and the number of orders for machinery.

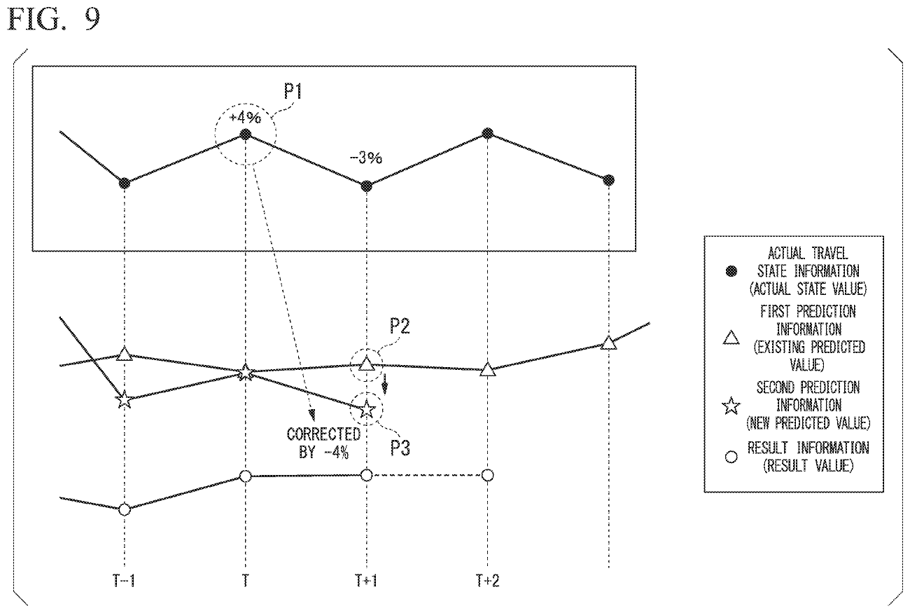

FIG. 9 is a (first) diagram illustrating a process of generating second prediction information 258. The second predictor 230 predicts the demand for a component using result values and indices of the actual travel state information 254 every predetermined period which are result values and indices at three or more time points. For example, the second predictor 230 predicts the demand for a component at time T+1 using indices of the actual travel state information 254 at times T−1 and T and predicts the demand for a component at time T+2 using indicates of the actual travel state information 254 at times T and T+1.

The second predictor 230 predicts the demand at time T+1 (an example of a “third time point”) on the basis of a shift of an index of the actual travel state information 254 at time T−1 (an example of a “second time point”) with respect to an index of the actual travel state information 254 at time T (an example of the “first time point”). For example, when the index of the actual travel state information 254 at time T tends to increase with respect to the index of the actual travel state information 254 at time T−1, the second predictor 230 sets a predicted value of the demand at time T+1 to be lower than the existing predicted value. When the index of the actual travel state information 254 at time T tends to decrease with respect to the index of the actual travel state information 254 at time T−1, the second predictor 230 sets the predicted value of the demand at time T+1 to be higher than the existing predicted value.

When the index of the actual travel state information 254 at time T tends to increase with respect to the index of the actual travel state information 254 at time T−1, the second predictor 230 predicts the demand at time T+1 on the basis of a value obtained by subtracting a magnitude of a difference between the index of the actual travel state information 254 at time T and the index of the actual travel state information 254 at time T−1 from the existing predicted value at time T+1. For example, when the index of the actual travel state information 254 at time T tends to decrease with respect to the index of the actual travel state information 254 at time T−1, the second predictor 230 predicts the demand at time T+1 on the basis of a value obtained by adding a magnitude of a difference between the index of the actual travel state information 254 at time T and the index of the actual travel state information 254 at time T−1 to the existing predicted value at time T+1.

For example, the process of acquiring second prediction information 258 at time T+1 in the future when the current time is time T will be described below. The second predictor 230 generates second prediction information 258 in which a value obtained by decreasing the existing predicted value of the first prediction information 256 at next time T+1 (P2 in FIG. 9) by 4% is set as a new predicted value (P3 in FIG. 9) because the actual travel state value (P1 in FIG. 9) of the actual travel state information 254 at time T is larger by 4% than the actual travel state value in the actual travel state information 254 at time T−1. The second predictor 230 predicts that there is a tendency of decrease after the demand has increased using feature 1 and predicts that the demand decreases by the degree of increase because the fluctuation has the same tendency using feature 2.

Instead of setting a value obtained by decreasing the existing predicted value by 4% as a new predicted value, a value obtained by applying a difference between the actual travel state value at time T and the actual travel state value at time T−1 to a function or a value calculated using a coefficient may be set as a new predicted value. Instead of the values, tendencies such as the tendency of increase or the tendency of decrease with respect to the existing predicted value may be calculated through the aforementioned process.

As described above, when the actual travel state value at a time of interest tends to increase with respect to that at a previous time, the second predictor 230 predicts a new predicted value by correcting the existing predicted value on the basis of the actual travel state value having the tendency of increase. Accordingly, the prediction device 200 can more accurately predict the demand for a component.

When the actual travel state value at a time of interest tends to decrease with respect to that at a previous time, the second predictor 230 may predict a new predicted value by correcting the existing predicted value on the basis of the actual travel state value having the tendency of decrease. Accordingly, the prediction device 200 can more accurately predict the demand for a component.

In this way, the second predictor 230 can more accurately predict the demand for a component by calculating a new predicted value by correcting the existing predicted value at a next time on the basis of characteristics in which the actual travel state value at a next time has a tendency opposite to the tendency of increase or decrease in the past actual travel state value (an operation value at a first time point and an operation value at a second time point) and the existing predicted value at the next time.

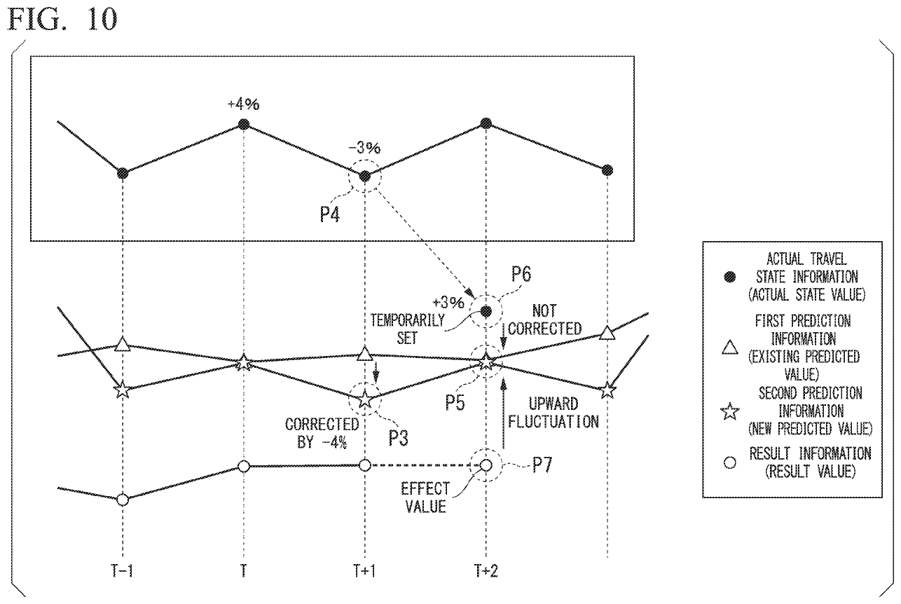

FIG. 10 is a (second) diagram illustrating the process of generating second prediction information 258. The second predictor 230 predicts the demand for a component on the basis of a result value of the demand, an actual travel state value, and an existing predicted value. The second predictor 230 predicts the demand on the basis of a relative relationship between an index acquired from the actual travel state value, the existing predicted value, and an index acquired from the result value. For example, the second predictor 230 determines whether the existing predicted value is to be employed as a predicted value or whether a value obtained by correcting the existing predicted value is to be employed as a predicted value on the basis of the relative relationship between the index acquired from the actual travel state value, the existing predicted value, and the index acquired from the result value.

For example, the process of acquiring second prediction information 258 at time T+2 in the future when the current time is time T+1 will be described below. The second predictor 230 temporarily sets a value obtained by increasing the existing predicted value at next time T+2 (P5 in FIG. 10) of the first prediction information 256 by 3% to a new predicted value (P6 in FIG. 10) as a predicted value at next time T+2 to because the actual travel state value (P4 in FIG. 10) in the actual travel state information 254 at time T+1 is smaller by 3% than the actual travel state value in the actual travel state information 254 at time T. The temporarily set new predicted value is an example of an “index acquired from the actual travel state value.” An effect value which will be described later is an example of an “index acquired from a result value” or an “index based on a result value.”

Then, the second predictor 230 calculates an effect value (P7 in FIG. 10) of the result value at time T+2. The effect value is a value acquired from the past tendency of the result value. The effect value is, for example, a value obtained by linearly extending a line connecting the result at time T and the result at time T+1.

The second predictor 230 compares the existing predicted value at time T+2 (P5 in FIG. 10) with the effect value (P7 in FIG. 10) of the result value at time T+2, and does not correct the temporarily set new predicted value and sets the existing predicted value as a new predicted value (P5 in FIG. 10) when the existing predicted value is predicted to increase with respect to the effect value of the result value (when a sign of a result of subtraction of the effect value from the existing predicted value is plus).

When the existing predicted value is increased with respect to the result value, a value based on the existing predicted value instead of the existing predicted value may be set as a new predicted value. The value based on the existing predicted value is, for example, a value obtained by correcting the existing predicted value to increase (or decrease). For example, the second predictor 230 may determine the new predicted value on the basis of the temporarily set new predicted value (the value obtained by increasing the existing predicted value) and the existing predicted value (the existing predicted value at the third time point) (for example, on the basis of a value based on a difference therebetween).

When the effect value is larger than the existing predicted value (or when both values are equal to or similar to each other), the temporarily set new predicted value (P6 in FIG. 10) may be set as a regular new predicted value or the existing predicted value may be set as a regular new predicted value.

As described above, the second predictor 230 determines whether the existing predicted value is to be employed as a new predicted value or whether the value obtained by performing correction based on the actual travel state value thereon is to be employed as a new predicted value using the actual travel state value, the effect value, and the existing predicted value. Accordingly, the prediction device 200 can more accurately predict the demand for a component.

The process described above with reference to FIG. 10 may be omitted and the process described above with reference to FIG. 9 may be performed.

### Flowchart

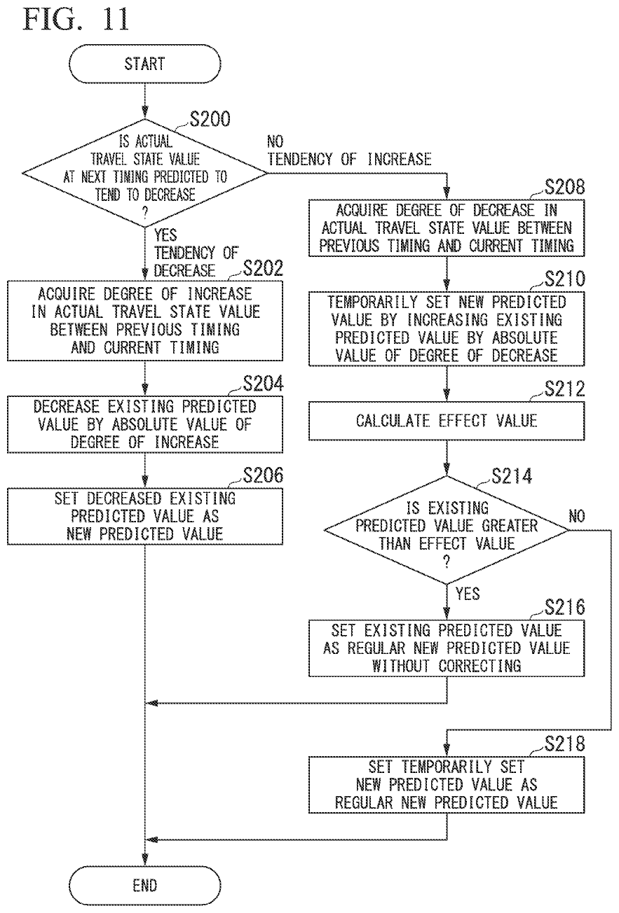

FIG. 11 is a flowchart illustrating an example of a process flow which is performed by the prediction device 200. First, the second predictor 230 of the prediction device 200 determines whether an actual travel state value at a next prediction time can be predicted to tend to decrease with respect to the actual travel state value at the current time on the basis of the tendency of the actual travel state values in the past (Step S200).

When it is predicted to tend to decrease, the second predictor 230 acquires a degree of increase of the current actual travel state value with respect to the previous actual travel state value (Step S202). Then, the second predictor 230 decreases the existing predicted value by an absolute value of the degree of increase (Step S204). Then, the second predictor 230 sets the decreased existing predicted value as a new predicted value (Step S206). Accordingly, one routine of the flowchart ends.

When it is predicted not to tend to decrease (it is predicted to tend to increase), the second predictor 230 acquires a degree of decrease of the current actual travel state value with respect to the previous actual travel state value (Step S208). Then, the second predictor 230 temporarily sets a new predicted value by increasing the existing predicted value by an absolute value of the degree of decrease (Step S210). Then, the second predictor 230 calculates an effect value on the basis of the result value (Step S212).

Then, the second predictor 230 determines whether the existing predicted value increases with respect to the effect value (Step S214). When the existing predicted value increases with respect to the effect value, the second predictor 230 does not correct the temporarily set new predicted value but sets the existing predicted value as a regular new predicted value (Step S216). When the existing predicted value does not increase with respect to the effect value, the second predictor 230 sets the temporarily set new predicted value as a regular new predicted value (Step S218). Accordingly, one routine of the flowchart ends.

The order of the processes may be changed, and some processes may be skipped. For example, when the existing predicted value increases with respect to the effect value, the process of temporarily setting a new predicted value may be skipped.

When the existing predicted value decreases with respect to the effect value, the same process as described above may be performed. For example, when the temporarily set new predicted value is smaller than the existing predicted value and the existing predicted value is smaller than the effect value, the second predictor 230 may not set the temporarily set new predicted value as a regular new predicted value but may set the existing predicted value as a regular new predicted value.

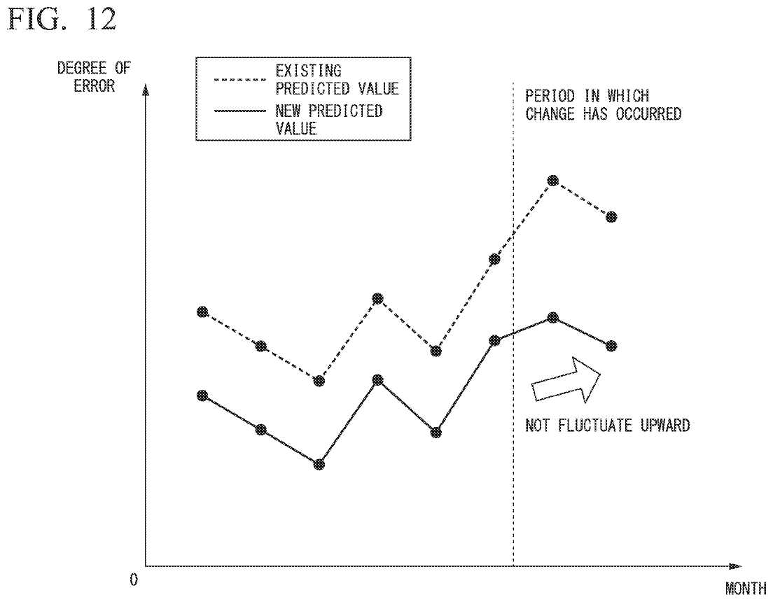

FIG. 12 is a diagram illustrating comparison between an existing predicted value and a new predicted value. FIG. 12 illustrates an error of an existing predicted value from a result value in a predetermined period and an error of a new predicted value from the result value in the predetermined period. As illustrated in FIG. 12, the error of the new predicted value in the predetermined period tends to be less than the error of the existing predicted value. It can be seen that the new predicted value is a prediction result with higher accuracy than the existing predicted value.

In a specific period of the predetermined period, it can be seen that the new predicted value has higher accuracy than the existing predicted value. The specific period is a period in which a social environment changes. Specifically, the specific period is a period in which social life is suppressed or economic activities are congested due to coronavirus. In the specific period, the error of the existing predicted value is larger than those in the other periods, but the error of the new predicted value is not excessively increased but tends to be at a standstill. This is because the prediction device 200 derives the new predicted value in consideration of actual travel states of vehicles M which are not measured in demand results for components and economic indicators, and the like (which are not reflected in the existing predicted value) as described above.

As described above, the prediction device 200 can predict the demand for a component with higher accuracy.

The prediction device 200 may perform the aforementioned processes when the demand for a component of a specific vehicle model or a specific component is predicted. For example, the prediction device 200 may perform the aforementioned processes when the demand for a component of a vehicle in which a vehicle size is equal to or less than a predetermined size, a front component, or a component for which the demand scale is equal to or greater than a predetermined scale is predicted. This is because prediction accuracy of a vehicle in which a vehicle size is equal to or less than a predetermined size tends to be higher than prediction accuracy of a vehicle in which a vehicle size is greater than the predetermined size, prediction accuracy of a front component tends to be higher than prediction accuracy of other components (for example, a rear component), and prediction accuracy of a component for which the demand scale is equal to or greater than the predetermined scale tends to be higher than prediction accuracy of a component for which the demand scale is less than the predetermined scale.

According to the aforementioned embodiment, the information processing device 100 can support more accurate prediction of the demand for a component in the prediction device 200 by providing the result value and the operation value to the prediction device 200.

According to the aforementioned embodiment, the prediction device 200 can more accurately predict the demand for a component on the basis of the result value and the operation value.

According to the aforementioned embodiment, the prediction device 200 can more accurately predict the demand for a component on the basis of the result value, the actual travel state value, and the existing predicted value. The results of prediction may be displayed, for example, on a display of a terminal device. A user can management the demand for a component on the basis of information displayed on the display. For example, the information processing device 100 or the prediction device 200 displays the results of prediction on the display.

While a mode for carrying out the present invention has been described above with reference to an embodiment, the present invention is not limited to the embodiment and can be subjected to various modifications or substitutions without departing from the gist of the present invention.

### REFERENCE SIGNS LIST

1 Prediction system
10 Vehicle system
20 Vehicle sensor
30 Navigation device
100 Information processing device
110 First acquirer
120 Second acquirer
130 Processor
142 Result information
144 Operation information
146 Collection information
148 Actual travel state information
200 Prediction device
210 Information manager
220 First predictor
230 Second predictor
240 Prediction provider
252 Result information
254 Actual travel state information
256 First prediction information
258 Second prediction information

1. A demand prediction device that predicts demand for a component of a vehicle in preparation for replacement or repair of the component, the demand prediction device comprising:
an acquirer configured to acquire a result value of the demand for the component, an operation value associated with operation of vehicles using the component, and an existing predicted value which is a predicted demand for the component; and
a predictor configured to predict the demand on the basis of the result value, the operation value, and the existing predicted value.

2. The demand prediction device according to claim 1, wherein the predictor predicts the demand on the basis of a relative relationship among an index acquired from the operation value, the existing predicted value, and an index acquired from the result value.

3. The demand prediction device according to claim 1, wherein the predictor determines whether the existing predicted value is to be employed as a predicted value or whether a value obtained by correcting the existing predicted value is to be employed as a predicted value on the basis of a relative relationship among an index acquired from a tendency of increase or decrease of the operation value, the existing predicted value, and an index acquired from the result value.

4. The demand prediction device according to claim 3, wherein the tendency of increase or decrease of the operation value in a time series is equal to or similar to a tendency of increase or decrease of the result value, and
wherein the predictor predicts the demand on the basis of the tendency of increase or decrease of the operation value and the tendency of increase or decrease of the result value in the time series.

5. The demand prediction device according to claim 3, wherein a tendency of fluctuation of the operation value in a time series is equal to or similar to a tendency of fluctuation of the result value, and
wherein the predictor predicts the demand on the basis of the tendency of fluctuation of the operation value and the tendency of fluctuation of the result value in the time series.

6. The demand prediction device according to claim 1, wherein the acquirer acquires the result value for every predetermined period, the operation value for every predetermined period, and the existing predicted value for every predetermined period, and
wherein the predictor determines a value obtained by decreasing the existing predicted value at a third time point later than a first time point as a predicted value on the basis of a difference between the operation value at the first time point and the operation value at a second time point earlier than the first time point when the operation value at the first time point tends to increase with respect to the operation value at the second time point.

7. The demand prediction device according to claim 1, wherein the acquirer acquires the result value for every predetermined period, the operation value for every predetermined period, and the existing predicted value for every predetermined period, and
wherein the predictor determines a value obtained by increasing the existing predicted value at a third time point later than a first time point as a predicted value on the basis of a difference between the operation value at the first time point and the operation value at a second time point earlier than the first time point when the operation value at the first time point tends to decrease with respect to the operation value at the second time point.

8. The demand prediction device according to claim 1, wherein the acquirer acquires the result value for every predetermined period, the operation value for every predetermined period, and the existing predicted value for every predetermined period,
wherein the predictor acquires an index based on the result value at a third time point later than a first time point on the basis of the result value at the first time point and the result value at a second time point earlier than the first time point, and
wherein the predictor compares the existing predicted value at the third time point and a magnitude of an index based on the result value and determines whether the existing predicted value at the third time point is to be used as a predicted value at the third time or whether a value obtained by correcting the existing predicted value at the third time point on the basis of the operation value at the first time point and the operation value at the second time point is to be used as the predicted value at the third time point on the basis of the result of comparison.

9. The demand prediction device according to claim 8, wherein the predictor determines the existing predicted value at the third time point to be the predicted value at the third time point when the existing predicted value at the third time point is equal to or greater than the index based on the result value, and
wherein the predictor determines a value obtained by correcting the existing predicted value at the third time point on the basis of the operation value at the first time point and the operation value at the second time point to be the predicted value at the third time point when the existing predicted value at the third time point is less than the index based on the result value.

10. The demand prediction device according to claim 1, wherein the operation value of vehicles is information indicating an actual travel state of the vehicles correlated with a predetermined area.

11. A demand prediction method of predicting demand for a component of a vehicle in preparation for replacement or repair of the component, the demand prediction method comprising:
acquiring a result value of the demand for the component;
acquiring an operation value associated with operation of vehicles using the component;
acquiring an existing predicted value which is a predicted demand for the component; and
predicting the demand on the basis of the result value, the operation value, and the existing predicted value.

12. A non-transitory storage medium storing a program, the program causing a computer to predict demand for a component of a vehicle in preparation for replacement or repair of the component, the program causing the computer to perform:
acquiring a result value of the demand for the component;
acquiring an operation value associated with operation of vehicles using the component;
acquiring an existing predicted value which is a predicted demand for the component; and
predicting the demand on the basis of the result value, the operation value, and the existing predicted value.
